(19) United States
(12) Patent Application Publication
(10) Pub. No.: US 2019/0104169 A1
(43) Pub. Date: Apr. 4, 2019

(54) METHODS AND COMPUTER PROGRAM PRODUCTS FOR TRANSCEIVING FILES THROUGH NETWORKS AND APPARATUSES USING THE SAME

(71) Applicant: Synology Inc., Taipei (TW)

(72) Inventors: Yi-Chi WU, Taipei (TW); Ching-Hua KUO, Taipei (TW); Tsung-Ching LIANG, Taipei (TW); Tung-Ying WU, Taipei (TW); Han CHIANG, Taipei (TW)

(73) Assignee: Synology Inc., Taipei (TW)

(21) Appl. No.: 15/989,818

(22) Filed: May 25, 2018

Related U.S. Application Data
(60) Provisional application No. 62/567,398, filed on Oct. 3, 2017.

(51) Int. Cl. H04L 29/08; G06F 17/30; H04L 29/06; H04L 12/26

(52) U.S. Cl. CPC H04L 67/06; G06F 17/30203; H04L 43/08; H04L 67/10; H04L 69/16

(57) ABSTRACT

The invention introduces an apparatus for transmitting files through networks, at least including a processing unit and a communications interface. The processing unit determines whether a real-time network situation is favorable; determines a first protocol over Transmission Control Protocol (TCP) to carry out a file upload or download task if the real-time network situation is favorable; determines a second protocol over User Datagram Protocol (UDP) to carry out the file upload or download task if the real-time network situation is not favorable; and sends or receives data fragments via the communications interface to or from a storage server using the determined protocol.

### CROSS-REFERENCE TO RELATED APPLICATIONS

This application claims the benefit of priority to U.S. Provisional Application Ser. No. 62/567,398, filed on Oct. 3, 2017; the entirety of which is incorporated herein by reference for all purposes.

### BACKGROUND

The disclosure generally relates to file transfer and, more particularly, to methods and computer program products for transceiving files through networks and apparatuses using the same.

A large file is divided into smaller datagrams and these datagrams are encapsulated into network packets to transfer to another site. Some datagrams may become damaged or lost when they travel through heterogeneous networks, such as any combinations of Local Area Network (LAN), wireless telephony network, the Internet, Personal Area Network (PAN) and the like. Typically, the file transfer from a client to a server (upload) or from a server to a client (download) employs File Transfer Protocol (FTP) over Transmission Control Protocol (TCP). TCP uses Positive Acknowledgment with Re-Transmission (PAR) to resend network packets which have been either damaged or lost. Specifically, PAR operates to verify receipt of transmitted data by the reception site. The transmission site re-transmits data for an established period of time until the reception site acknowledges reception of the data. However, PAR consumes excessive bandwidth to transceive Acknowledgments (ACKs) and Negative Acknowledgments (NACKs). Moreover, in some situations, the networks may be congested, leading to latency of replied ACKs and unnecessary data retransmission. Thus, it is desirable to have methods and computer program products for transceiving files through networks and apparatuses using the same to address the aforementioned problems.

### SUMMARY

In view of the foregoing, it may be appreciated that a substantial need exists for methods, computer program products and apparatuses that mitigate or reduce the problems above.

In an aspect of the invention, the invention introduces an apparatus for transmitting files through networks, at least including a processing unit and a communications interface. The processing unit determines whether a real-time network situation is favorable; determines a first protocol over Transmission Control Protocol (TCP) to carry out a file upload or download task if the real-time network situation is favorable; determines a second protocol over User Datagram Protocol (UDP) to carry out the file upload or download task if the real-time network situation is not favorable; and sends or receives data fragments to or from a storage server by the determined protocol via the communications interface.

In another aspect of the invention, the invention introduces a method for transmitting files through networks, performed by a processing unit of a client, comprising: determining whether a real-time network situation is favorable; determining a first protocol over TCP to carry out a file upload or download task if the real-time network situation is favorable; determining a second protocol over UDP to carry out the file upload or download task if the real-time network situation is not favorable; and sending or receiving a plurality of data fragments to or from a storage server by the determined protocol via the communications interface.

In another aspect of the invention, the invention introduces a non-transitory computer program product for transmitting files through networks when being executed by a processing unit of a client, the computer program product comprising program code to: determine whether a real-time network situation is favorable; determine a first protocol over TCP to carry out a file upload or download task if the real-time network situation is favorable; determine a second protocol over UDP to carry out the file upload or download task if the real-time network situation is not favorable; and send or receive a plurality of data fragments to or from a storage server by the determined protocol via the communications interface.

Both the foregoing general description and the following detailed description are examples and explanatory only, and are not restrictive of the invention as claimed.

### BRIEF DESCRIPTION OF THE DRAWINGS

FIG. 1 is a schematic diagram of the network architecture according to an embodiment of the invention.

FIG. 2 is the system architecture of a Network-Attached Storage (NAS) system according to an embodiment of the invention.

FIG. 3 is the system architecture of a client according to an embodiment of the invention.

FIG. 4 is a schematic diagram illustrating protocol stacks implemented in a processing unit with a communications interface of a storage server and a processing unit with a communications interface of a client according to an embodiment of the invention.

FIG. 5 is the software architecture included in a storage server and a client according to an embodiment of the invention.

FIG. 6 is a schematic diagram illustrating a message flow for generating a peer seed according to an embodiment of the invention.

FIG. 7 is a schematic diagram illustrating a message flow for evaluating the real-time network situation according to an embodiment of the invention.

FIG. 8 is a flowchart illustrating a method for determining which one of the standard and proprietary protocols to use to perform a file upload or download task, according to an embodiment of the invention.

FIG. 9 is a schematic diagram illustrating a message flow for transceiving data fragments according to an embodiment of the invention.

FIG. 10 is the block diagram illustrating the protocol architecture employed in a file-source node and a file-destination node according to an embodiment of the invention.

FIG. 11 is a flowchart illustrating a method for detecting missing data fragments, performed by a sequencer of a file-destination node, according to an embodiment of the invention.

FIG. 12 is a flowchart illustrating a method for reporting the missing data fragments to a file-source node, performed by a sequencer of a file-destination node, according to an embodiment of the invention.

FIGS. 13A to 13G are schematic diagrams illustrating a series of scenarios for reporting missing data fragments to the file-source node according to an embodiment of the invention.

FIGS. 14A and 14B are flowcharts illustrating a method for adjusting a transfer rate of a file-source node, performed by a rate controller of a file-destination node, according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

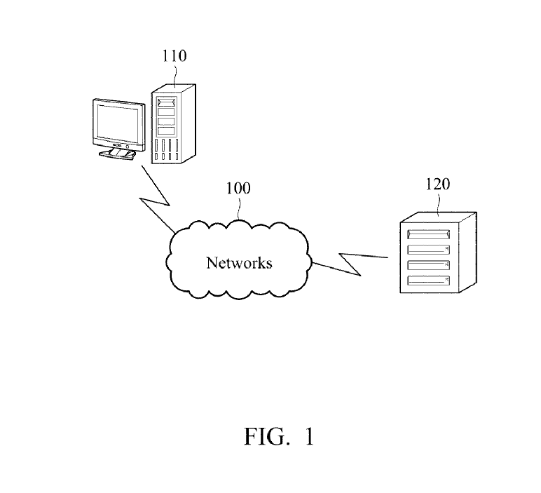

An embodiment of the invention introduces network architecture containing at least a client and a server to communicate each other for uploading or/and downloading files. FIG. 1 is a schematic diagram of the network architecture according to an embodiment of the invention. The storage server 120 may provide storage capacity for storing a wide range of electronic files, such as Web pages, word processing files, text files, spreadsheets, digital photos, video files, acoustic files, etc. The client 110 may upload/download electronic files to/from the storage server 120 after being authenticated by the storage server 120. The storage server 120 may request an ID (Identification) and a password from the client 110 before a file upload or a file download. The client 110 starts to access files after passing the authentication. The access to the file is prohibited when the storage server 120 determines that the client 110 is not a legal user after examining the ID and the password. The client 110 may access data of the storage server 120 via the networks 100, where the networks 100 may include a Local Area Network (LAN), a wireless telephony network, the Internet, a Personal Area Network (PAN) or any combination thereof. The storage server 120 may be practiced in a Network-Attached Storage (NAS) system, a cloud storage server, or others. The client may be practiced in a Personal Computer (PC), a laptop computer, a tablet computer, a mobile phone, a digital camera, a digital recorder, an electronic consumer product, or others.

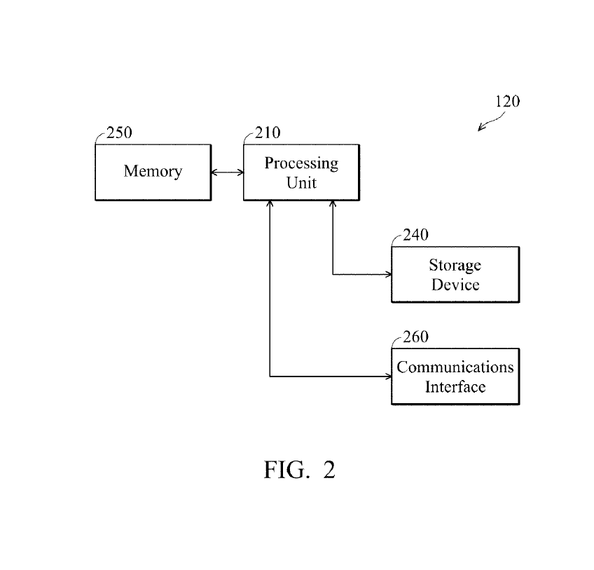

FIG. 2 is the system architecture of a NAS system according to an embodiment of the invention. The processing unit 210 can be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The processing unit 210 may contain at least an ALU and a bit shifter. The ALU is multifunctional device that can perform both arithmetic and logic function. The ALU is responsible for performing arithmetic operations, such as add, subtraction, multiplication, division, or others, Boolean operations, such as AND, OR, NOT, NAND, NOR, XOR, XNOR, or others, and mathematical special functions, such as trigonometric functions, a square, a cube, a power of n, a square root, a cube root, a n-th root, or others. Typically, a mode selector input (M) decides whether ALU performs a logic operation or an arithmetic operation. In each mode different functions may be chosen by appropriately activating a set of selection inputs. The bit shifter is responsible for performing bitwise shifting operations and bitwise rotations. The system architecture further includes a memory 250 for storing necessary data in execution, such as variables, data tables, data abstracts, or others. A storage device 240 may be configured as Redundant Array of Independent Disks (RAID) and stores a wide range of electronic files, such as Web pages, word processing files, spreadsheet files, presentation files, video files, audio files, or others. A communications interface 260 is included in the system architecture and the processing unit 210 can thereby communicate with the client 110, or others. The communications interface 260 may be a LAN communications module, a Wireless Local Area Network (WLAN), or any combination thereof.

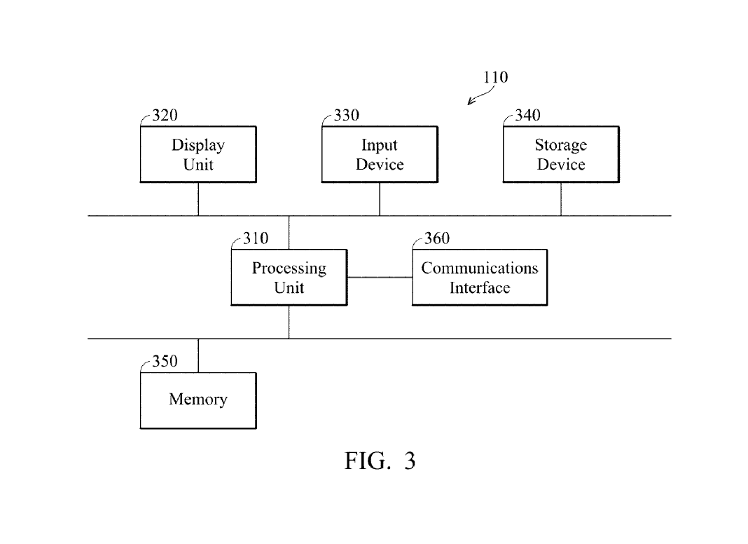

FIG. 3 is the system architecture of a client according to an embodiment of the invention. A processing unit 310 can be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The processing unit 310 may contain at least an ALU and a bit shifter. The system architecture further includes a memory 350 for storing necessary data in execution, such as runtime variables, data tables, etc., and a storage device 340 for storing a wide range of electronic files, such as Web pages, word processing files, spreadsheet files, presentation files, video files, audio files, or others. A communications interface 360 is included in the system architecture and the processing unit 310 can thereby communicate with the storage server 120, or others. The communications interface 360 may be a LAN/WLAN/Bluetooth communications module, a 2G/3G/4G/5G telephony communications module, or others. The system architecture further includes one or more input devices 330 to receive user input, such as a keyboard, a mouse, a touch panel, or others. A user may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. A display unit 320, such as a Thin Film Transistor Liquid-Crystal Display (TFT-LCD) panel, an Organic Light-Emitting Diode (OLED) panel, or others, may also be included to display input letters, alphanumeric characters and symbols, dragged paths, drawings, or screens provided by an application for the user to view.

The whole file may be divided into data fragments and the data fragments may be encapsulated in network packets, e.g. IP (Internet Protocol) packets, or others, to travel through the networks 100. Of the client 110 and the storage server 120, the one that sends the data fragments may be referred to as a file-source node, while the one that receives the data fragments may be referred to as a file-destination node. For example, the storage server 120 operates as a file-source node in a file download but a file-destination node in a file upload. The client 110 may selectively employ a standard protocol, such as Hypertext Transfer Protocol (HTTP), File Transfer Protocol (FTP), etc., and a proprietary protocol, such as Internet Transfer Accelerator Protocol (ITAP), etc. to transfer and receive data fragments therebetween according to the real-time network situation. In alternative embodiments, those skilled in the art may implement a proprietary protocol over TCP that practice the PAR mechanism with relevant modifications, and the invention should not be limited thereto. The client 110 may employ HTTP or FTP to handle the file transfer if the real-time network situation is favorable. On the other hand, the client 110 may employ ITAP to handle the file transfer if the real-time network situation is unfavorable. The real-time network situation may be reflected according to the Round-Trip Time (RTT). In data communications, the RTT may be defined in the time required for one or more network packets to travel from one node to the other node and back again. This time delay includes the propagation times for the paths between the client 110 and the storage server 120. For example, if the RTT is shorter than 20 ms (milliseconds), which may be referred to as a favorable situation, the client 110 uses the standard protocol to exchange files with the storage server 120. On the other hand, if the RTT equals or is longer than 20 ms, which is referred to as an unfavorable situation, the client 110 uses the proprietary protocol to exchange files with the storage server 120. 20 ms can be considered as an exemplary threshold to distinguish whether the real-time network situation is favorable or not. However, the threshold may vary, based on the current network infrastructure, and the invention should not be limited thereto. For example, the threshold may be set to an arbitrary time, ranging from 18 to 22 ms.

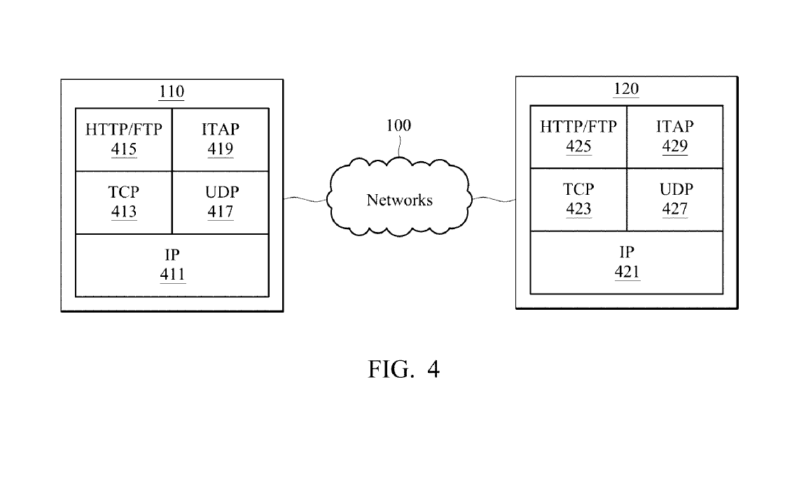

FIG. 4 is a schematic diagram illustrating protocol stacks implemented in the processing unit 210 with the communications interface 260 of the storage server 120 and the processing unit 310 with the communications interface 360 of the client 110 according to an embodiment of the invention. HTTP/FTP 415 and 425 mutually transfer and receive data fragments over TCP 413 or 423. TCP 413 or 423 operates as a transport layer protocol in an upper layer for IP 411 or 421 operating in a network layer. TCP 413 or 423 implements a PAR (Positive Acknowledgment with Re-Transmission) mechanism to provide reliability for the storage server 120 or the client 110 to acknowledge the data fragment it receives from the other node. For example, the communications interface 260 of the storage server 120 sends data fragments with unique sequence numbers (or packet IDs) to the client 110. When receiving a data fragment, the communications interface 260 of the client 110 sends an ACK (acknowledgment) having the same sequence number as the received data fragment. However, data fragments and ACKs may experience loss during transmission through the networks 100. Or, data fragments and ACKs sent by the file-source node may be delayed to the file-destination node. TCP 413 or 423 of the file-source node handles this by setting a timeout when it sends one data fragment, and if the data fragment isn't acknowledged when the timeout expires, it resends the data fragment. It is apparent that the file-source node needs to wait for an ACK for each data fragment. When the real-time network situation is unfavorable with a higher latency resulting from a longer transmission path, crowded or poor-quality networks, the file-source node and the file-destination node may consume excessive computation capacity to handle retransmissions of data fragments in TCP. Moreover, the bandwidth of the networks 100 may be degraded when unnecessary retransmissions are requested. Therefore, in an aspect of the invention, the embodiments introduce the proprietary protocol ITAP to avoid or reduce unnecessary retransmissions of data fragments when the real-time network situation is unfavorable.

ITAP 419 and 429 mutually transfer and receive data fragments over UDP (User Datagram Protocol) 417 or 427. UDP 417 or 427 operates as a transport layer protocol in an upper layer for IP 411 or 421 operating in a network layer. UDP 417 or 427 uses a simple model with a minimum of protocol mechanisms and does not implement the retransmission mechanism or anything similar, as described above. ITAP 419 and 429 provide an ITA retransmission mechanism to respond to the unfavorable situation with a higher latency so as to not only ensure reliability between the file-source node and the file-destination node but also to avoid spending excessive time waiting for ACKs. Details of the ITA retransmission mechanism are described in the following paragraphs.

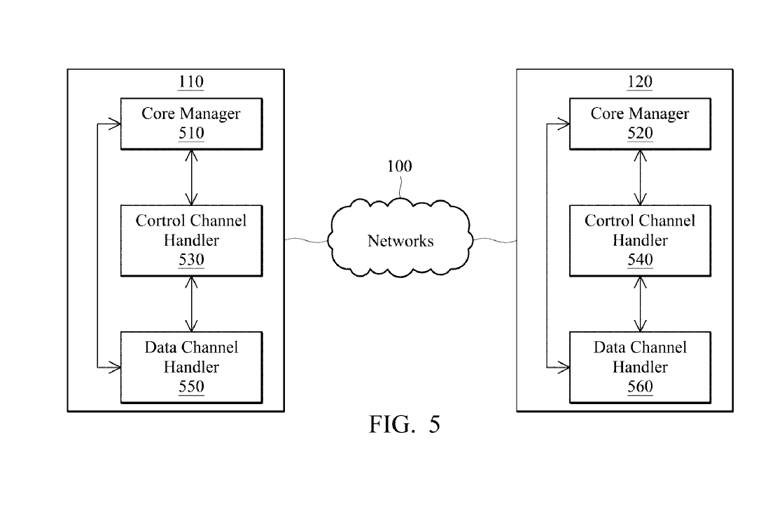

FIG. 5 is the software architecture included in the storage server 120 and the client 110 according to an embodiment of the invention. The software architecture of the client 110 includes a core manager 510, a control channel handler 530 and a data channel handler 550. The software architecture of the storage server 120 includes a core manager 520, a control channel handler 540 and a data channel handler 560. The software architectures of the client 110 and the storage server 120 are symmetric and the functionalities thereof are complementary to each other.

The core managers 510 and 520 are data model classes and each data model class maintains information regarding tasks and identifiers. The task information is associated with a file that will be transferred, is transferring, or has been transferred. The task information may include the source path of the file-source node, the destination path of the file-destination node, the file size (in bytes), etc. The source path may include an IP address or a DNS (Domain Name System) name, a directory and a file name of the file-source node to indicate where the file is come from, for example, “192.168.128.10/NAS1/Videos/a.mp4”, “Synology/NAS1/Videos/a.mp4”, or others. The destination path may similarly include an IP address or a DNS name, a directory and a file name of the file-destination node to indicate where the file is, for example, “192.192.100.20/Collections/Videos/a.mp4”, “TomWolfe/Collections/Videos/a.mp4”, or others. The task information may include a user action triggered by a user through an MMI (man machine interface) resident in the client 110. The user action may indicate a start, a pause, or an abort of a file transceiving. The task information may further include details of the file transceiving, such as the start time, the duration, the finished time, the current progress in percentage, or the quantity of data fragments that have been transferred or received.

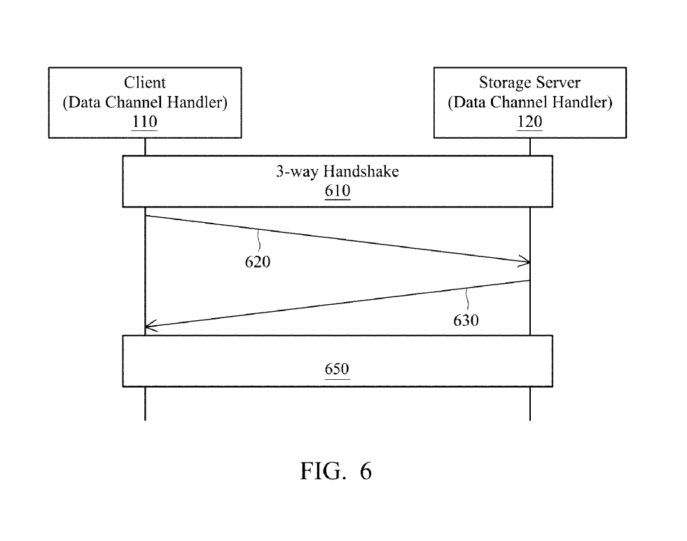

The identifier information is used to identify a particular peer node, a connection and a task. Three types of identifiers may be provided: the peer seed; the transfer seed; and the file token. The peer seed may be a device-level UID (unique identifier) to communicate with a particular peer node. FIG. 6 is a schematic diagram illustrating a message flow for generating a peer seed according to an embodiment of the invention. In order to obtain a peer seed, the client 110 (specifically, the data channel handler 550) asks the storage server 120 (specifically, the core manager 520) for a peer seed through TCP. TCP is a connection-oriented protocol that requires handshaking to set up node-to-node communications. Once a TCP connection is set up, user data may be sent bi-directionally over the TCP connection. Specifically, the client 110 and the storage server 120 may use 3-way handshake 610 to authenticate each other. After the 3-way handshake 610 is successful, a TCP connection with a specified port number is established between the client 110 and the storage server 120. The client 110 may issue a login request 620 with a client ID and a password PWD through the established TCP connection to the storage server 120. The storage server 120 may store an account-management database in the storage device 240. The account-management database stores records and each record contains an ID and a password associated with the ID. The storage server 120 inspects the account-management database and accordingly determines whether the client ID of the login request is recorded in the account-management database and the password PWD of the login request is correct. If the client ID is found and the password PWD is correct, the storage server 120 generates a peer seed PSeed for the client 110 and stores mapping information between the client 110 and the peer seed PSeed in the memory 250 and/or the storage device 240. Additionally, the storage server 120 replies to the client 110 through the established TCP connection with a login response including the peer seed PSeed and a status indicating that the login request has been permitted. Otherwise, the storage server 120 replies to the client 110 through the established TCP connection with a login response including a status indicating that the login request has been rejected because of an incorrect client ID or password. In alternative embodiments, the storage server 120 may simply ignore the login request. Once receiving the peer seed PSeed, the core manager 510 stores the peer seed PSeed in the memory 350 and/or the storage device 340. After that, the client 110 and the storage server 120 follow a standard procedure 650 to terminate the established TCP connection (port #).

The client 110 may establish one or more TCP connections with the storage server 120 and each TCP connection is used to realize a file transceiving. The transfer seed is a connection-level UID to identify a particular TCP connection for a file that will be transferred, is transferring, or has been transferred. Each peer seed may be associated with one or more transfer seeds to indicate that one or more TCP connections have been established with a particular peer node. Each time a new transfer seed is generated, each of the core managers 510 and 520 stores a map of the transfer seed to the peer seed in a corresponding storage device and/or a memory, enabling the transfer seed to be traced back to the peer seed. The mappings of the transfer seeds to the peer seed may be implemented in a two-dimensional array, a linked list, a data table, structured records, or others.

The file token is a connection-level UID to identify a particular UDP connection for a file that will be transferred, is transferring, or has been transferred. Conventionally, UDP is a message-based connectionless protocol that does not set up a dedicated node-to-node connection. No means are applied to distinguish one file transceiving from the others and trace the progress of the file transceiving through UDP. Thus, the data channel handlers 550 and 560 of a higher layer may use file tokens to distinguish the transceiving of one file from that of the others. The core managers 510 and 520 use the same pseudorandom number generator to generate one or more file tokens from the stored peer seed. The pseudorandom number generator is an algorithm for generating a sequence of numbers (i.e. file tokens) whose properties approximate the properties of sequences of random numbers. Since the pseudorandom number generators applied in the core managers 510 and 520 are the same, the generated sequences of numbers by the core managers 510 and 520 are also the same. Moreover, each time a new file token is generated, each of the core managers 510 and 520 stores a map of the newly generated file token to the peer seed in a corresponding memory and/or a corresponding storage device, enabling the new file token to be traced back to the peer seed. The mappings of the file tokens to the peer seed may be implemented in a two-dimensional array, a linked list, a data table, structured records, or others.

Moreover, the core managers 510 and 520 further include an extensible program-code-template for creating objects, providing initial values for the task and token information, and implementations of behavior, such as functions, methods, etc.

The control channel handler 530 includes program codes and software instructions that can be loaded and executed with data abstracts by the processing unit 310 of the client 110 for handling file browsing commands generated by a file manager (for example, in an OS, Operating System). The file browsing commands may include a directory list command, a directory traverse command, a directory creation command, a file/directory copy command, a file/directory paste command, a file/directory movement command, a file/directory rename command, a file/directory deletion command, or something similar. A user may activate the file manager and operate an MMI provided by the file manager. The file manager is run by the processing unit 310 to issue the file browsing command to the control channel handler 530 according to a user action on the MMI.

The directory list command may be generated by the file manager to request information from a local file system or storage server 120 regarding files and/or folders included in a particular directory, such as folder names, file names, file sizes, etc. The directory traverse command may be generated by the file manager to request that the local file system or storage server 120 move the current position to the root directory, move the current position to the upper folder, or move the current position down to a particular folder, etc. The directory creation command may be generated by the file manager to request that the local file system or storage server 120 create a new folder in a particular directory path. The file deletion command may be generated by the file manager to request that the local file system or the storage server 120 remove a particular file from a specific directory path. The directory deletion command may be generated by the file manager to request that the local file system or the storage server 120 remove a particular folder from a specific directory path. The file rename command may be generated by the file manager to request that the local file system or the storage server 120 replace the filename of a particular file in a specific directory path with a new one. The directory rename command may be generated by the file manager to request that the local file system or the storage server 120 give the folder name of a particular folder in a specific directory path a new name.

When receiving the request corresponding to the directory list command, the directory traverse command, the directory creation command, the file deletion command, the directory deletion command, the file rename command, directory rename command, or others, from the client 110, the control channel handler 540 drives a file manager (for example, in an OS-operating system) to perform a corresponding operation according to the request.

The file copy command may be generated by the file manager to ask the local file system or the storage server 120 to locate a particular file (i.e. a source file) in a specific directory path (i.e. a source directory path), and then, the file paste command may be generated by the file manager to ask the local file system or the storage server 120 to transfer a copy of the located file to a designated directory path (i.e. a destination directory path). The directory copy command may be generated by the file manager to locate a particular folder in a specific directory path (i.e. a source directory path), and then, the directory paste command may be issued to request the creation of a corresponding folder in a specific directory path (i.e. a destination directory path) and to transfer copies of all the subfolders and files of the located folder to the newly created folder. The file movement command may be generated by the file manager move a particular file from a source directory path to a destination directory path. The directory movement command is issued to move all the subfolders and files from a source directory path to a destination directory path. If the source directory path is governed by the local file system of the client 110 and the destination directory path is governed by a file system of the storage server 120 for the aforementioned file paste, directory paste, file movement or directory movement command, or others, the control channel handler 530 determines that one or more file uploads are triggered. The control channel handler 530 may instruct the core manager 510 to create one or more tasks for uploading the files to the storage server 120. If the source directory path is governed by the file system of the storage server 120 and the destination directory path is governed by the local file system of the client 110 for the aforementioned file paste, directory paste, file movement or directory movement command, or others, the control channel handler 530 determines that one or more file downloads have been triggered. The control channel handler 530 may instruct the core manager 510 to create one or more tasks for downloading the files from the storage server 120.

The file system may be NTFS (New Technology File System), FAT (File Allocation Table), exFAT (Extended File Allocation Table) or Btrfs (B-tree file system), but it is not limited thereto. It should be understood that the local file system run on the processing unit 310 of the client 110 may provide API (Application Programming Interface) to interact with the control channel handler 530 to perform the file access operations. Moreover, the file system run on the processing unit 210 of the storage server 120 may provide API to interact with the control channel handler 540 to perform the file access operations. The file access operations may include opening, closing, reading, writing a file, changing a filename, moving a file, or something similar.

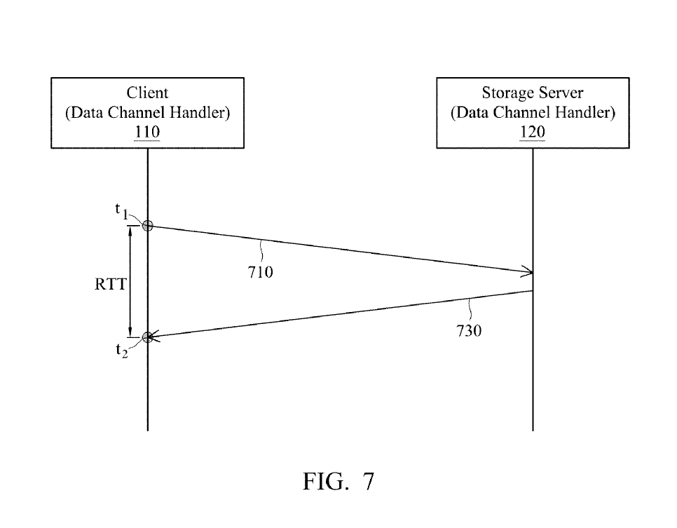

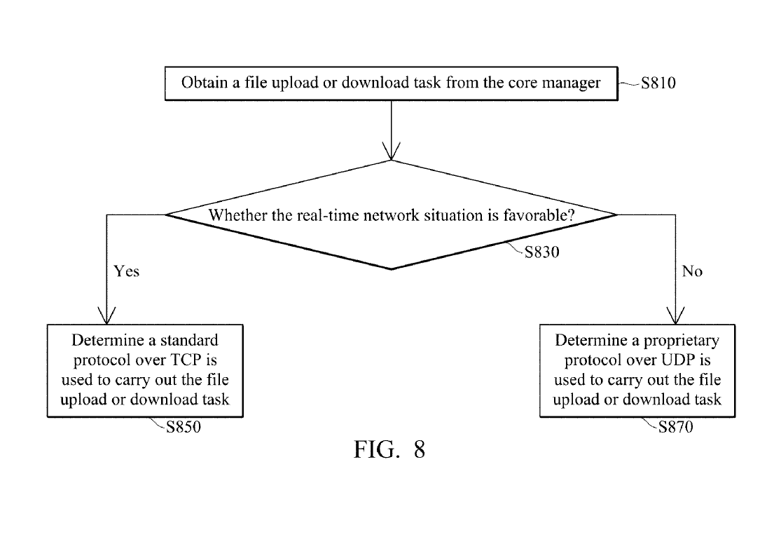

The data channel handler 550 includes program codes and software instructions that can be loaded and executed with data abstracts by the processing unit 310 for communicating with the storage server 120 (specifically, the data channel handler 560). Specifically, the data channel handler 550 implements at least the protocols 411 to 419 and the data channel handler 560 implements at least the protocols 421 to 429 to communicate with each other. FIG. 8 is a flowchart illustrating a method for determining which one of the standard and proprietary protocols to use to perform a file upload or download task, according to an embodiment of the invention. Each time a file upload or download task is obtained from the core manager 510 (step S810), the data channel handler 550 determines whether the real-time network situation is favorable (step S830). If the real-time network situation is favorable (the “Yes” path of step S830), a standard protocol (for example, HTTP, FTP or others) over TCP is determined to carry out the file upload or download task (step S850). Otherwise (the “No” path of step S830), the proprietary protocol over UDP (for example, ITAP or others) is used to carry out the file upload or download task (step S870). FIG. 7 is a schematic diagram illustrating a message flow for evaluating the real-time network situation according to an embodiment of the invention. The data channel handler 550 of the client 110 obtains a new file token from the core manager 510, sends a UDP packet at least including an RTT request 710 and the obtained file token to the storage server 120 (specifically, the data channel handler 560) at the moment t1. The core manager 510 may generate the new file token using the pseudorandom number generator and send to the data channel handler 550. In response to the received RTT request 710 and the file token, the data channel handler 560 asks the core manager 520 to examine whether the included file toke is correct, and when the included file token is correct, sends a UDP packet at least including an RTT response 730 and the file token to the data channel handler 550. The core manager 520 may generate the next file token using the pseudorandom number generator thereof and checks if the generated file token is the same as that included in the RTT request. When receiving the RTT response 730 at the moment t2, the data channel handler 550 may calculate an RTT between moments t1 and t2. If the calculated RTT is lower than a threshold (e.g. 20 ms), the data channel handler 550 determines that the real-time network environment is favorable and employs the standard protocol over TCP to transceive data fragments between the client 110 and the storage server 120. Otherwise, the data channel handler 550 determines that the real-time network environment is unfavorable and employs the proprietary protocol over UDP to transceive data fragments between the client 110 and the storage server 120.

When the real-time network environment is favorable, the data channel handler 550 may employ HTTP or FTP 415 to perform a file upload or a file download from or to the storage server 120 (specifically, coordinating with the data channel handler 560 employing HTTP or FTP 425). HTTP/FTP 415 adopts TCP 413 with the PAR mechanism to guarantee the reliability between the client 110 and the storage server 120. It is well-known by those skilled in the art that HTTP/FTP 415 may be used to complete a file upload or a file download from or to the storage server 120, and detailed descriptions of the file upload and file download processes have been omitted for brevity.

After determining that the real-time network environment is unfavorable, the data channel handler 550 employs ITAP 419 to perform a file upload or a file download from or to the storage server 120 (specifically, coordinating with the data channel handler 560 employing ITAP 429).When a file upload is to be performed, the data channel handler 550 asks the core manager 510 to generate a new file token according to the peer seed and takes the responsibility of the file-source node to send the file of the source directory path of the storage device 340 to the storage server 120 (specifically, the data control channel 560), ensure the reliability of data transceiving and perform rate control.

When a file download is to be performed, the data channel handler 550 requests that the core manager 510 generate a new file token according to the peer seed and sends a message with the source directory path and the filename of the file to the data channel handler 560 through a TCP connection or UDP packets to indicate that the file has been requested for download by ITAP. The data channel handler 560 may pass the file download message to the control channel handler 540 and instruct the core manager 520 to create a task for sending the designated file to the client 110 through ITAP 429. Once the task is created by the core manager 520, the data channel handler 560 asks the core manager 520 to generate a new file token according to the peer seed and takes the responsibility of the file-source node to send the file of the source directory path of the storage device 240 to the client 110 (specifically, the data control channel 550), to ensure the reliability of data transceiving and perform rate control. Since the same pseudorandom number generator is used, the new file tokens generated by the core managers 510 and 520 are the same. Moreover, since UDP 417 and 427 do not guarantee the reliability in data transceiving between the client 110 and the storage server 120 and optimize the bandwidth utilization, ITAP 419 and 429 are responsible for detecting and resending lost UDP packets (i.e. data fragments) to ensure the reliability of data transceiving between the client 110 and the storage server 120 and determining a transmission rate according to the real-time network situation to optimize the bandwidth utilization.

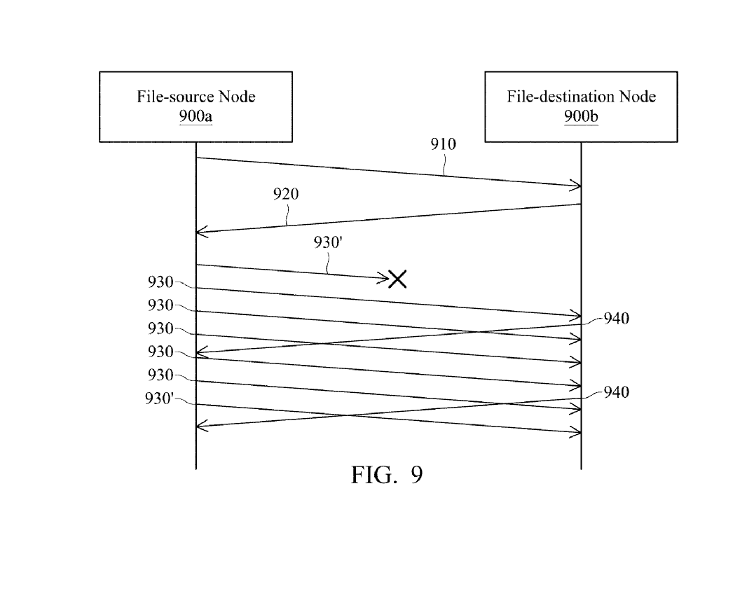

Of the client 110 and the storage server 120 (specifically, the data channel handler 550 and 560), one operates as the file-source node (also referred to as a sender) for sending data fragments of a file in the source directory path, while the other operates as the file-destination node (also referred to as a receiver) for receiving data fragments of a file in the destination directory path. FIG. 9 is a schematic diagram illustrating a message flow for transceiving data fragments for a file upload task according to an embodiment of the invention. To complete a file upload task (from the client 110 to the storage server 120), the file-source node 900a generates a push file header 910 at least including information about the file token associated with the file to be sent, the destination directory path, the file size, etc. and sends a UDP packet including the push file header 910 to the file-destination node 900b. After receiving the push file header 910, the file-destination node 900b checks whether the file-source node 900a has permission to write the file in the destination directory path and the storage space of the file-destination node 900b is enough to write the file. When it passes the inspection, the file-destination node 900b sends a UDP packet including a push file acknowledgement 920 carrying the file token to inform the file-source node 900a that the requested file transmission can be started. After receiving the push file acknowledgement 920, the file-source node continuously sends UDP packets carrying the file token, the data fragments and their position information 930 until the file upload is aborted or paused by a user, or completes. On the other hand, to complete a file download task (from the storage server 120 to the client 110), the file-destination node (not shown in FIG. 9) generates a pull file header at least including information about the file token associated with the file to be received, the source directory path, the file size, etc. and sends a UDP packet including the pull file header to the file-source node (not shown in FIG. 9). After receiving the pull file header, the file-source node checks whether the file-destination node has permission to read the file in the source directory path. When it passes the inspection, the file-source node sends a UDP packet including a pull file acknowledgement carrying the file token to inform the file-destination node that the requested file reception can be started. After that, the file-source node continuously sends UDP packets carrying the file token, the data fragments and their position information until the file download is aborted or paused by a user, or completes. The file token and position information for each data fragment may be recorded in a UDP header, such as in a source port number field, a destination port number field, an arbitrary field, or an arbitrary combination thereof, or in predefined bytes of UDP data. The position information may be represented as a start offset and an end offset in bytes, for example the 0^{th} to 1023^{th}, the 512^{th} to 1023^{th} bytes of the file, or others. It should be noted that the file-destination node 900b does not send an acknowledgement for each data fragment to the file-source node 900a to avoid the consumption of network bandwidth, especially in an unfavorable network situation. On the other hand, the file-source node 900a does not set a timeout when it sends one data fragment, wait for an acknowledgement for the sent data fragment, and resend the data fragment when the sent data fragment isn't acknowledged and the timeout expires, like TCP does. The transfer rate for sending the data fragments may be controlled by rate control mechanism applied in the file-source node 900a. Details of the rate control mechanism are discussed in the following paragraphs. The file-destination node 900b continuously receives the UDP packets carrying the file token, the data fragments and their position information 930 from the file-source node 900a. In addition, the file-destination 900b periodically generates a report 940 indicating which portions of the file have been received or have not been received successfully and sends a UDP packet carrying the report 940 to the file-source node 900a. Data fragments that have not been received successfully may mean that the data fragments are lost from the networks 100, have errors that cannot be corrected by the file-destination node 900b, or are delayed to the file-destination node 900b and fail to receive until the report 940 is generated. The periodicity for sending reports may be fixed to a predefined time period or varied with the real-time network situation. Each time the report 940 is received from the file-destination node 900b, the file-source node 900a finds out which data fragments have not been received by the file-destination node 900b successfully and sends UDP packets carrying the missing data fragments 930′ to the file-destination node 900b again.

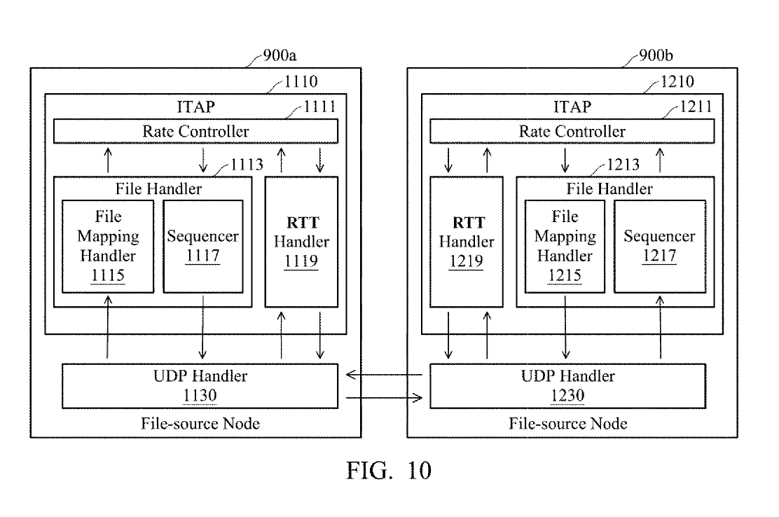

FIG. 10 is the block diagram illustrating the protocol architecture employed in the file-source node 900a and the file-destination node 900b according to an embodiment of the invention. Although the file-source node 900a and the file-destination node 900b have the same protocol architecture, the behaviors acted in the file-source node 900a are different from but complementary to that acted in the file-destination node 900b. The ITAP 1110 of the file-source node 900a includes a rate controller 1111, a file handler 1113 and an RTT handler 1119 while the ITAP 1210 of the file-destination node 900b includes a rate controller 1211, a file handler 1213 and an RTT handler 1219.

The RTT handler 1119 periodically generates the RTT request 710 and sends the RTT request 710 to the file-destination node 900b via the UDP handler 1130 while the RTT handler 1219 generates the RTT response 730 and sends the RTT response 730 to the file-source node 900a via the UDP handler 1230. The RTT handler 1219 periodically sends RTT requests to the file-source node 900a and receives RTT responses from the file-source node 900a, calculates RTTs according to pairs of the moments at which the RTT request has been sent and the corresponding RTT response has been received and reports the calculated RTTs to the rate controller 1211. Each RTT request sent by the file-source node 900a or the file-destination node 900b may comprise a unique (i.e. a newly generated) file token and the peer node may respond to the RTT request with a RTT response comprising the same file token. Detailed calculations for RTTs may be deduced by analogy with references made to FIG. 7. Moreover, each RTT response may include a sender rate, which is the rate at which the file-source node 900a is currently sending data fragments, so that the file-destination node 900b can know the actual rate at which the file-source node 900a is configured.

The file handler 1113 includes a file mapping handler 1115 and a sequencer 1117 while the file handler 1213 includes a file mapping handler 1215 and a sequencer 1217. The file handler 1113 generates the push file header 910 and sends the push file header 910 to the file-destination node 900b via the UDP handler 1130 while the file handler 1213 generates the push file acknowledgement 920 and sends the push file acknowledgement 920 to the file-source node 900a via the UDP handler 1230. After that, the file mapping handler 1115 uses API released by the file system of the file-source node 900a to read the file from the source directory path. The file handler 1113 continuously sends data fragments 930 to the file-destination node 900b via the UDP handler 1130 while the file handler 1213 continuously receives the data fragments 930 from the file-source node 900a via the UDP handler 1230. The sequencer 1217 monitors the received data fragments 930, determines the missing data fragments, and accordingly generates or modifies the report 940 and sends the report 940 to the file-source node 900a when the next reporting moment has been reached. It should be noted that the sequencer 1217 does not send the report 940 immediately when detecting any missing data fragment because the data fragments are arrived to the file-destination node 900b out-of-order resulting from different traveling paths may be chosen for the data fragments by the intermediary nodes of the networks 100 and the missing data fragment may be received sooner after. The sequencer 1117 resends the missing data fragments 930′ to the file-destination node 900b via the UDP handler 1130. After all the data fragments of the file has been received completely, the file mapping handler 1215 uses API released by the file system of the file-destination node 900b to write the file in the destination directory path. Reference may be made to FIG. 9 for descriptions of the push file header 910, the push file acknowledgement 920, the data fragments 930, the missing data fragments 930′ and the report 940. The UDP handler 1130 implements UDP to communicate with the UDP handler 1230, and vice versa. The UDP handlers 1130 and 1230 may be realized by combined software and hardware to send and receive requests, responses, data fragments, reports, or others.

The sequencer 1217 continuously receives UDP packets from a file-source node 900a, wherein each UDP packet comprises a data fragment of a file and position information of the data fragment. Contrary to PAR employed in TCP, the sequencer 1217 detects a missing data fragment according to information of the received data fragments, calculates a timeout moment for the missing data fragment, and asks the file-source node to resend the missing data fragment after the timeout moment has expired. Since the sequencer 1217 does not acknowledge every data fragment sent from the file-source node 900a, the traffic is much lighter than that applied by PAR and is suitable for the unfavorable real-time network situation. Each UDP packet is composed of two parts: a header and a datagram. The data fragment is stored in the datagram. Position information of each data fragment may be stored in a field of the header, or predefined bits of the datagram. The position information defines the location of the file in which the data fragment resides, and may be represented as a start offset and an end offset, or by a start offset and the length of the data fragment. The file token associated with the file may be stored in a field of the header, or predefined bits of the datagram. The file token identifies which file contains the received data fragment.

To detect the missing data fragments, the sequencer 1217 stores pending-bytes records in a memory and/or a storage device of the file-destination node 900b and each pending-bytes record contains information about the missing data fragment 930′. The information about the missing data fragment 930′ may be represented as {Start_Offset, End_Offset, Timeout}, where Start_Offset indicates the start offset of the missing data fragment 930′, End_Offset indicates the end offset of the missing data fragment 930′ and Timeout indicates the timeout moment for the missing data fragment. The sequencer 1217 expects the missing data fragment 930′ to be received before the timeout moment. At every reporting moment, the sequencer 1217 selects some pending-bytes records satisfying the reporting condition (for example, the pending-bytes record whose timeout moment has expired) and adds the selected pending-bytes records in the report 940 to request that the file-source node 900a resend the missing data fragments. The sequencer 1217 further stores ack-bytes records in the memory and/or the storage device of the file-destination node 900b and each ack-bytes record contains information about the missing data fragment 930′ that has been requested to resend through the report 940. The information about the requested data fragment 930′ may be represented as {Start_Offset, End_Offset}, where Start_Offset indicates the start offset of the requested data fragment 930′ and End_Offset indicates the end offset of the requested data fragment 930′. FIG. 11 is a flowchart illustrating a method for detecting missing data fragments, performed by the sequencer 1217 of the file-destination node 900b, according to an embodiment of the invention. The process continuously receives UDP packets comprising the file token associated with a file, the data fragments and their position information (or the EOF, End Of File) from the file-source node 900a (step S1111) and generates and/or updates pending-bytes records in response to the reception of the data fragments (steps S1113 to S1153) until the EOF has been received and no pending-bytes record is existed.

Specifically, each time a UDP packet including the file token, a data fragment and its position information is received (step S1111), the corresponding pending-bytes record is updated if necessary (step S1113) and the corresponding ack-bytes record is updated if necessary (step S1115). If the received data fragment (also referred to as the currently received data fragment) is not associated with any of the stored pending-bytes records and ack-bytes records, none of the stored pending-bytes records or ack-bytes records is updated. If the received data fragment is associated with any pending-bytes record, the sequencer 1217 determines that the received data fragment is the missing data fragment and the associated pending-bytes record needs to be updated. For example, DAT represents the received UDP packet, DAT.start_offset represents the start offset of the received data fragment, DAT.end_offset represents the end offset of the received data fragment, REC represents the associated pending-bytes record, REC.start_offset represents the start offset of the missing data fragment, REC.end_offset represents the end offset of the missing data fragment, and REC.timeout represents the timeout moment waiting for the missing data fragment. Pseudo code for updating the associated pending-bytes record is provided below:

If (DAT.start_offset==REC.start_offset) and (DAT.end_offset==REC.end_offset) then delete REC;
if (REC.start_offset>DAT.start_offset>REC.end_offset) and (DAT.end_offset==REC.end_offset) then set REC.end_offset to DAT.start_offset−1;
if (DAT.start_offset==REC.start_offset) and (REC.start_offset>DAT.end_offset>REC.end_offset) then set REC.start_offset to DAT.end_offset+1;
if (REC.start_offset>DAT.start_offset>REC.end_offset) and (REC.start_offset>DAT.end_offset>REC.end_offset) then new pending-bytes record REC1; set REC1.start_offset to DAT.end_offset+1; set REC1.end_offset to REC.end_offset; set REC1.timeout to REC.timeout; set REC.end_offset to DAT.start_offset−1.
If the received data fragment is associated with any pending-bytes records and the corresponding ack-bytes record, the sequencer 1217 determines that the received data fragment is the resent data fragment and the associated pending-bytes and ack-bytes records need to be updated. In addition to the exemplary notations for the received UDP packet DAT and the pending-bytes record REC, ACK represents the associated ack-bytes record, and ACK.start_offset represents the start offset of the requested data fragment. Pseudo code for updating the associated pending-bytes record is provided below:
if (DAT.start_offset==REC.start_offset==ACK.start_offset) and (DAT.end_offset==REC.end_offset==ACK.end_offset) then delete REC and ACK;
if (REC.start_offset==ACK.start_offset>DAT.start_offset>REC.end_offset==ACK.end_offset) and (DAT.end_offset==REC.end_offset==ACK.end_offset) then set REC.end_offset and ACK.end_offset to DAT.start_offset−1;
if (DAT.start_offset==REC.start_offset==ACK.start_offset) and (REC.start_offset==ACK.start_offset>DAT.end_offset>REC.end_offset==ACK.end_offset) then set REC.start_offset and ACK.start_offset to DAT.end_offset+1;
if (REC.start_offset==ACK.start_offset>DAT.start_offset>REC.end_offset==ACK.end_offset) and (REC.start_offset==ACK.start_offset>DAT.end_offset>REC.end_offset==ACK.end_offset) then {new pending-bytes record REC1 and ack-bytes record ACK1; set REC1.start_offset and ACK1.start_offset to DAT.end_offset+1; set REC1.end_offset and ACK1.end_offset to REC.end_offset; set REC1.timeout to REC.timeout; set REC.end_offset and ACK.end_offset to DAT.start_offset−1}.

The sequencer 1217 further determines whether any data fragments have been lost (step S1131). If so, the sequencer 1217 calculates a timeout moment for the missing data fragment (step S1133) and generates a pending-bytes record storing information about the missing data fragment and the calculated timeout moment (step S1135). The sequencer 1217 may determine whether the start offset of the received UDP packet is greater than the maximum of the end offsets of all the previously received data fragments plus one. The maximum of the end offsets of all the previously received data fragments plus one indicates the start offset of the data fragment that is expected to be received. When the start offset of the received UDP packet equals the maximum of the end offsets of all the previously received data fragments plus one, the sequencer 1217 determines that the data fragments have been received in order and no data fragment between the previously received data fragment with the maximum end offset and the currently received data fragment has been lost. Otherwise, the sequencer 1217 determines that the data fragments have been received out of order and a data fragment between the previously received data fragment (with the maximum end offset) and the currently received data fragment has been lost. Once it is detected that a data fragment between the previously received data fragment with the maximum end offset and the currently received data fragment has been lost, the sequencer 1217 may generate a timeout moment TO for the missing data fragment using Equation (1):

TO=T_now+Len_missing/RTT_current,

where TO represents the timeout moment, T_now represents the current time, Len_missing indicates the length of the missing data fragment, and RTT_current represents the latest RTT generated by the RTT handler 1219. The Equation takes the real-time network situation into account to reasonably expect the timeout for the missing data fragment.
The start offset of the generated pending-bytes record is set to the maximum of the end offsets of all the previously received data fragments plus one, and the end offset of the generated pending-bytes record is set to the end offset of the currently received data fragment.
The sequencer 1217 further determines whether the EOF is included in the received UDP packet (step S1151) and whether any pending-bytes records exist (step S1153). When an EOF is detected (the “Yes” path of step S1151) and no pending-bytes record exists (the “Yes” path of step S1153), the sequencer 1217 determines that all the data fragments of the file have been received.

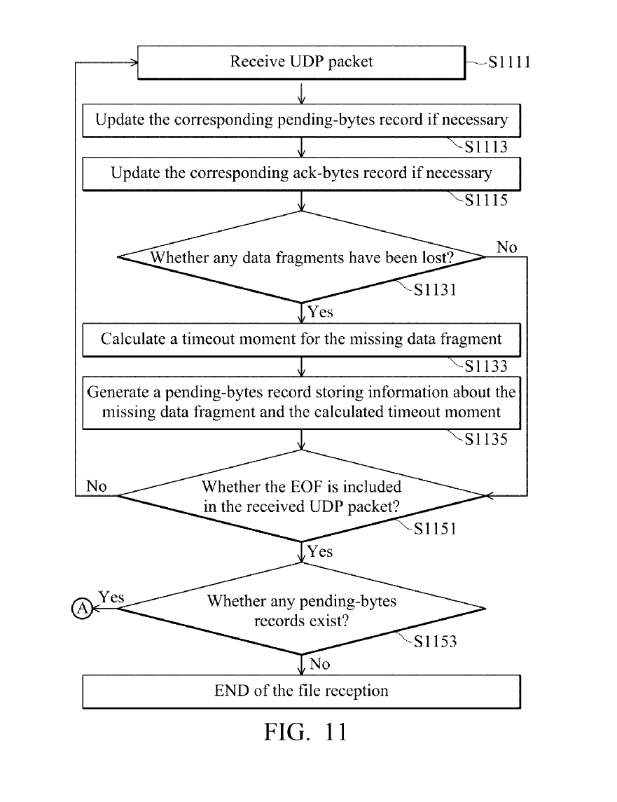

FIG. 12 is a flowchart illustrating a method for reporting the missing data fragments to the file-source node 900a, performed by the sequencer 1217 of the file-destination node 900b, according to an embodiment of the invention. Each time the first or the next reporting moment has been reached (step S1210), the process repeatedly performs a loop for determining whether each pending-bytes record needs to be included in the report 940 (steps 1231 to S1237). After all the pending-bytes records have been processed (the “Yes” path of step S1237), the sequencer 1217 sends a UDP packet including the report 940 and the file token to the file-source node 900a (step S1250). In each iteration, the sequencer 1217 reads the first or the next pending-bytes record (step S1231), and determines whether the timeout moment of the pending-bytes record has expired (step S1233). If so (the “Yes” path of step S1233), a corresponding ack-byte record is generated and the ack-bytes record is inserted into the report 940 (step S1235). The generated ack-byte record includes ACK.start_offset=REC.start_offset and ACK.end_offset=REC.end_offset. After sending the UDP packet including the report 940 and the file token to the file-source node 900a (step S1250), the sequencer 1217 may additionally calculate the total number of lost bytes and the total number of received bytes for a time period since the last reporting moment and store a reception status record including the total number of lost bytes, the total number of received bytes, and the reporting moment in a memory and/or a storage device of the file-destination node (step S1270). The information stored in the reception status record will be used by the rate controller 1211 for calculating the loss rate for a period of time.

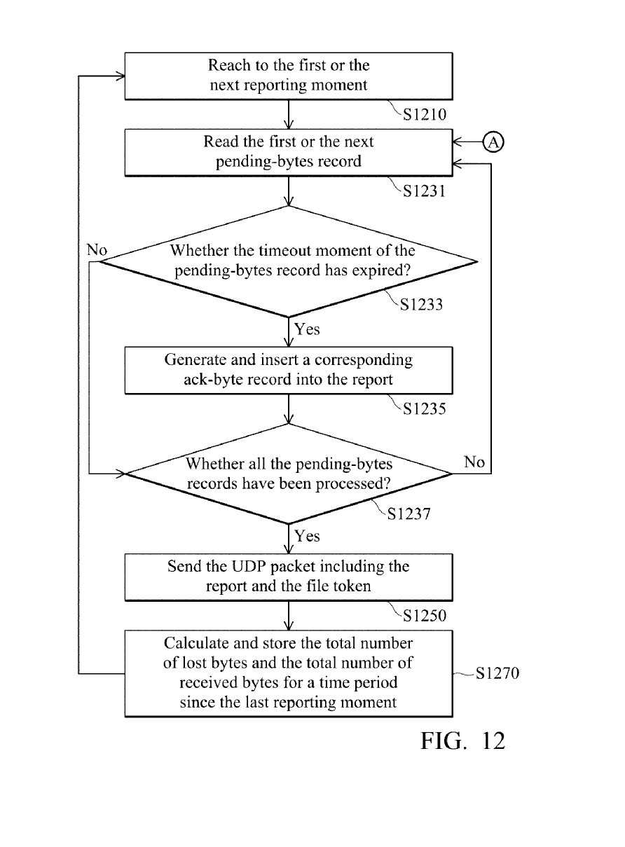

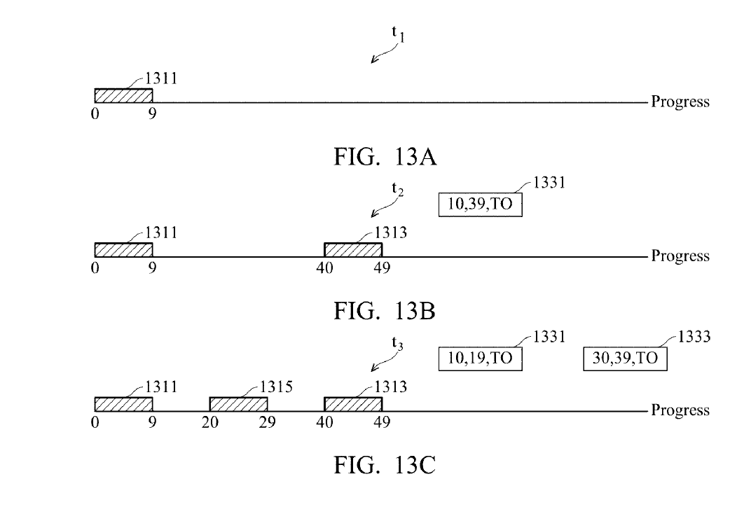

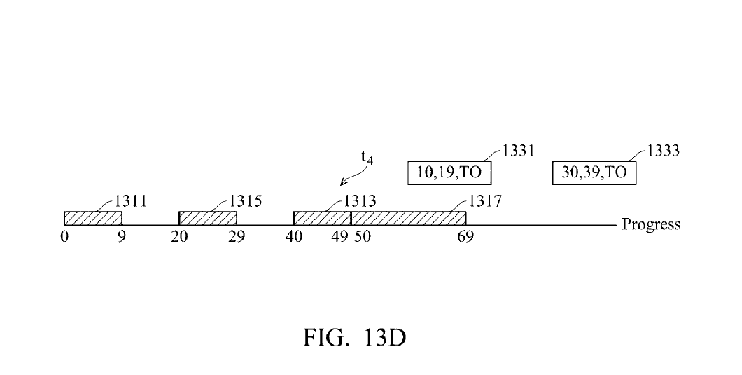

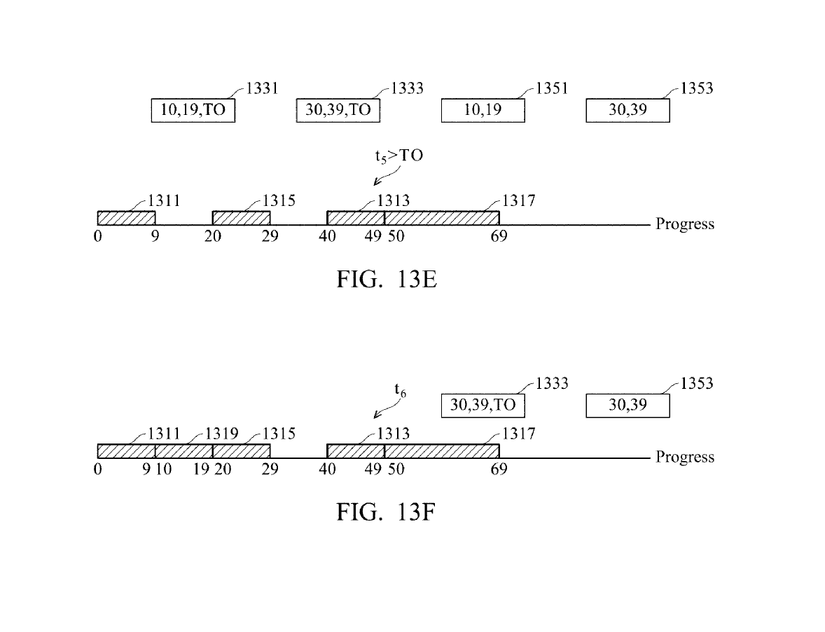

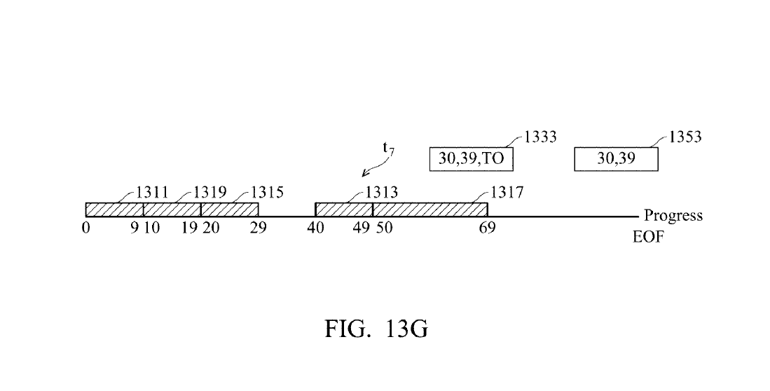

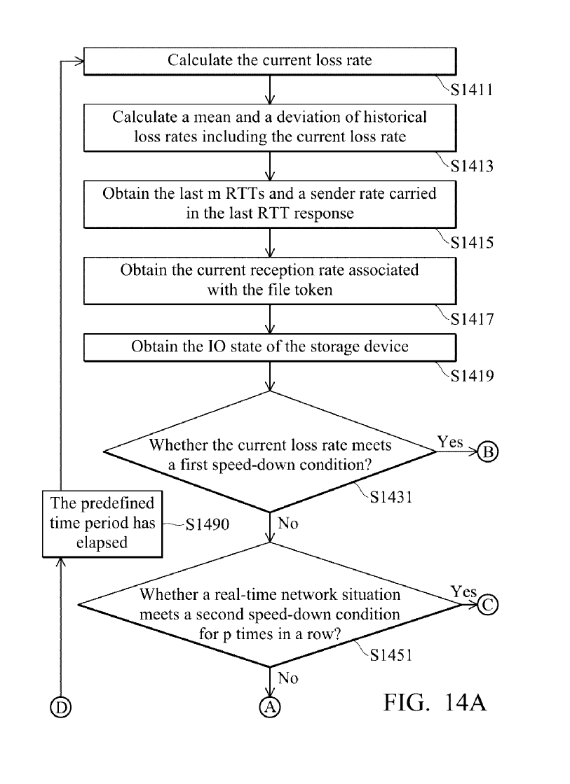

FIGS. 13A to 13G are schematic diagrams illustrating a series of scenarios for reporting missing data fragments to the file-source node according to an embodiment of the invention.

Refer to FIG. 13A. At the moment t₁, the sequencer 1217 receives the UDP packet including the data fragment (e.g. the 0^{th} to 9^{th} bytes) 1311 of the file from the file-source node 900a (step S1111).

Refer to FIG. 13B. At the moment t₂, the sequencer 1217 receives a UDP packet including the data fragment (e.g. the 40^{th} to 49^{th} bytes) 1313 of the file from the file-source node 900a (step S1111), determines that the data fragment (e.g. the 9^{th} to 39^{th} bytes) has been lost (the “Yes” path of step S1131), calculates the timeout moment TO (step S1133), and generates the pending-bytes record {10, 39, TO} 1331 (step S1135).

Refer to FIG. 13C. At the moment t₃, the sequencer 1217 receives a UDP packet including the data fragment (e.g. the 20^{th} to 29^{th} bytes) 1315 of the file from the file-source node 900a (step S1111), updates the End_Offset of the pending-byte record 1331 with 19 and generates a new pending-bytes record {30, 39, TO} (step S1113).

Refer to FIG. 13D. At the moment t₄, the sequencer 1217 receives the UDP packet including the data fragment (e.g. the 50^{th} to 69^{th} bytes) 1317 of the file from the file-source node 900a (step S1111).

Refer to FIG. 13E. At the reporting moment t₅ later than the timeout moment TO (i.e. t₅>TO), the sequencer 1217 generates two ack-bytes records {10,19} 1351 and {30,39} 1353, updates the timeout moments of the pending-bytes records 1331 and 1333 with “NULL”(step S1235) and sends the report 940 including the ack-bytes records {10,19} 1351 and {30,39} 1353 for requesting the file-source node 900a to resend the missing data fragments (e.g. the 10^{th} to 19^{th} bytes and the 30^{th} to 39^{th} bytes) (step S1250). The timeout moments of the pending-bytes records 1331 and 1333 being “NULL” indicate that the missing data fragments have been reported to the file-source node 900a to request that the file-source node 900a resend that. Moreover, the sequencer 1217 may additionally determine that the loss bytes are 20 bytes and the received bytes are 50 bytes and store a reception status record including the reporting moment t₅, the loss bytes being 20 bytes and the received bytes being 50 bytes in the memory and/or the storage device of the file-destination node 900b (step S1270).

Refer to FIG. 13F. At the moment t₆, the sequencer 1217 receives the UDP packet including the missing data fragment (e.g. the 10^{th} to 19^{th} bytes) 1319 of the file from the file-source node 900a (step S1111). The pending-bytes record 1331 and the ack-bytes record 1351 are deleted (steps S1113 and S1115).

Refer to FIG. 13G. At the moment t₇, the sequencer 1217 receives the UDP packet including the EOF from the file-source node 900a (step S1111), sends the report 940 including the ack-bytes record {30,39} 1353 for requesting the file-source node 900a to resend the missing data fragments (e.g. the 30^{th} to 39^{th} bytes) again (step S1250). Moreover, the sequencer 1217 may additionally determine that the loss bytes are 10 bytes and the received bytes are 10 bytes and store a reception status record including the reporting moment t₇, the loss bytes being 10 bytes and the received bytes being 10 bytes in the memory and/or the storage device of the file-destination node 900b (step S1270).

The rate controller 1211 of the file-destination node 900b may collect relevant parameters and determine whether the collected parameters show that a speed-up or a speed-down condition has been met every predefined time period (e.g. arbitrary time period ranging from 4 ms to 6 ms). When the speed-up or speed-down condition has been met, the rate controller 1211 of the file-destination node 900b calculates a new transfer rate and informs the rate controller 1111 of the file-source node 900a of the new transfer rate through the RTT handler 1219. Thereafter, the rate controller 1111 instructs the file handler 1117 to send or resend the rest of the data fragments of the file associated with a file token at the new transfer rate.

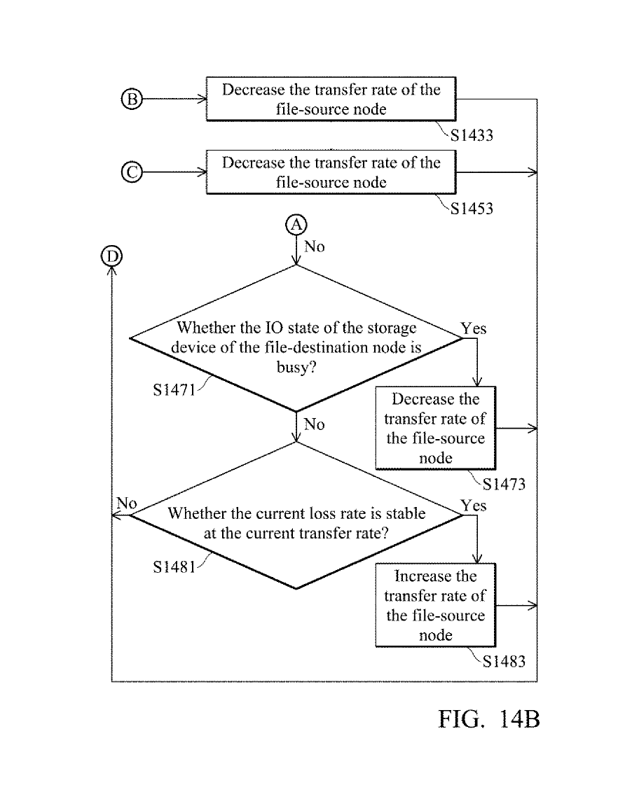

FIGS. 14A and 14B are flowcharts illustrating a method for adjusting a transfer rate of the file-source node 900a, performed by the rate controller 1211 of the file-destination node 900b, according to an embodiment of the invention. The process performs a loop every predefined time period (e.g. arbitrary time period ranging from 4 ms to 6 ms). Generally, in each iteration, the rate controller 1211 collects relevant parameters (step S1411 to S1419) and speeds up (i.e. increases) or slows down (i.e. decreases) the transfer rate of the file-source node 900a when the collected parameters show that a speed-up or a speed-down condition has been met (steps S1431 to S1483). Since the real-time network situation is not favorable, the method examines at least one speed-down condition first because the possibility of getting worse may be higher than that of getting better in file transceiving. Examining speed-down condition first may be efficient to find a proper direction to adjust the transfer rate. After all speed-down conditions are not met, the method examine the speed-up condition to determine whether the transfer rate needs to be increased.

The rate controller 1211 collects the reception status records associated with the file token from the sequencer 1217, the memory or the storage device of the file-destination node and calculates the current loss rate according to the collected reception status records (step S1411). In some embodiments, the rate controller 1211 may sort the reception status records in descending order according to the reporting moments. After that, the rate controller 1211 filters out the reception status records for a preset time and keeps the filtered ones that accumulatively store a preset quantity (or fewer) of the received UDP packets. The quantity of the received UDP packets may be set to an integer ranging from 50 to 150 and the preset time period may be set to any ranging from 0.5 to 2 seconds depending on the system requirements. The current loss rate may be calculated using Equation (2):

current_loss_rate=Σᵢ₌₁^{N}LostBytesᵢ/Σᵢ₌₁^{N}(RcvBytesᵢ+LostBytesᵢ),

where current_loss_rate represents the current loss rate, N represents the total number of filtered reception status records, LostBytesᵢ represents the total number of lost bytes of the i^{th} reception status record, and RcvBytes, represents the total number of received bytes of the i^{th} reception status record. The current loss rate LossRate_{curr} is stored in the memory and/or the storage device of the file-destination node 900b for calculating a mean and a deviation of historical loss rates later.

The rate controller 1211 calculates a mean and a deviation of historical loss rates including the current loss rate (step S1413). The quantity of historical loss rates may be set to an integer ranging from 80 to 120 depending on the system requirements.

The rate controller 1211 may obtain the last m RTTs and a sender rate carried in the last RTT response from the RTT handler 1219, where m may be set to an integer ranging from 6 to 10 (step S1415).

The rate controller 1211 may obtain the current reception rate associated with the file token indicating how many bytes have been received per second from the file handler 1217 (step S1417). The file handler 1213 may refresh current_rate every predefined time period (e.g. arbitrary time period ranging from 4 ms to 6 ms).

The rate controller 1211 may obtain the IO state of the storage device of the file-destination node 900b from the file handler 1213 (step S1419). The IO state being busy indicates that the storage device of the file-destination node 900b is reading or writing file, or others. Otherwise, the obtained IO state is idle.

The rate controller 1211 may determine whether the current loss rate meets (or satisfies) a first speed-down condition (step S1431). If so (the “Yes” path of step S1431), the rate controller 1211 decreases the transfer rate and informs the rate controller 1111 of the file-source node 900a of the calculated transfer rate through the RTT handler 1219 (step S1433). The first speed-down condition may be expressed by the following Equation (3):

current_loss_rate>loss_rate_mean+3×loss_rate_dev,

where current_loss_rate represents the current loss rate, loss_rate_mean represents the mean of historical loss rates and loss_rate_dev represents the deviation of historical loss rates. The current loss rate is calculated in step S1411. The mean and the deviation of historical loss rates are calculated in step S1413. If the current loss rate is greater than the average of the historical loss rates plus three times the deviation of the historical loss rates, the current loss rate is significantly worse than the average of historical loss rates in statistics and the transfer rate at which the file-source node 900a sends the data fragments needs to slow down, where the historical loss rates are associated with the file token. The transfer rate may be adjusted using Equation (4):

new_rate=max(current_rate, previous_set_rate)/2,

where new_rate represents the calculated transfer rate, max( ) is the maximum function, current_rate represents the current reception rate and previous_set_rate represents the last transfer rate that was instructed to the rate controller 1111. The current reception rate is obtained in step S1417. Moreover, if the current loss rate is greater than the average of the historical loss rates plus three times the deviation of the historical loss rates, a credit for speed up linear_speed_up_credit is increased by any integer ranging from 2 to 4. The credit for speed up is used to maintain the adjustment stability. Specifically, when the transfer rate is decreased since the current loss rate meets the first speed-down condition, the credit for speed up is increased. When the credit for speed up is greater than 0, the transfer rate cannot be increased to avoid it is changed dramatically.

After detecting that the current loss rate does not meet the first speed-down condition (the “No” path of step S1431), the rate controller 1211 may determine whether a real-time network situation meets a second speed-down condition for p times in a row (step S1451). p may be set to an integer ranging from 3 to 5. If so (the “Yes” path of step S1451), the rate controller 1211 decreases the transfer rate and informs the rate controller 1111 of the file-source node 900a of the calculated transfer rate through the RTT handler 1219 (step S1453). The second speed-down condition may be expressed by the following Equations (5) and (6):

RTT>min_RTT;

sender_rate×(1−loss_rate_mean)>current_rate,

where RTT represents the latest RTT, min_RTT represents the minimum of the last m RTTs except for the latest RTT, sender_rate represents the sender rate, loss_rate_mean represents the mean of historical loss rates, and current_rate represents the current reception rate. The last m RTTs and the sender rate are obtained in step S1415. The mean of historical loss rates is calculated in step S1413. The current reception rate is obtained in step S1417. It may indicate that the file-origin node 900a sends data fragments too fast to be processed by the file-destination node 900b when the latest RTT and the sender rate meet a second speed-down condition. The rate controller 1211 does not decrease the transfer rate once the latest RTT and the sender rate meet the second speed-down condition to avoid this happening occasionally. Rather, the rate controller 1211 needs to confirm that happen for p time in a row. The rate controller 1211 may maintain a counter initialized to 0. The counter records how many times that the latest RTT and the sender rate meet the second speed-down condition in a row. The counter is increased by one once the rate controller 1211 detects that the latest RTT and the sender rate meet the second speed-down condition. The counter is set to 0 once the rate controller 1211 detects that the latest RTT and the sender rate do not meet the second speed-down condition. The transfer rate may be adjusted using Equation (7):

new_rate=current_rate−(sender_rate−current_rate),

where new_rate represents the calculated transfer rate, current_rate represents the current reception rate and sender_rate represents the sender rate. The current reception rate is obtained in step S1417. The sender rate is obtained in step S1415.

After detecting that the latest RTT and the sender rate do not meet a second speed-down condition for p time in a row (the “No” path of step S1451), the rate controller 1211 may determine whether the IO state of the storage device of the file-destination node 900b is busy (step S1471). If so (the “Yes” path of step S1471), the rate controller 1211 decreases the transfer rate and informs the rate controller 1111 of the file-source node 900a of the calculated transfer rate through the RTT handler 1219 (step S1473). It may cause more packet loss when the storage device of the file-destination node 900b is busy. The IO state of the storage device of the file-destination node 900b is obtained in step S1419. The transfer rate may be adjusted using Equation (8):

new_rate=max_sender_rate×0.9,

where new_rate represents the calculated transfer rate and max_sender_rate represents the maximum transfer rate at which the file-origin node 900a sends data fragments by UDP packets.

After detecting that the IO state of the storage device of the file-destination node 900b is not busy (the “No” path of step S1271), the rate controller 1211 may determine whether the current loss rate is stable at the current transfer rate configured by the file-origin node 900a (step S1481). If so (the “Yes” path of step S1481), the rate controller 1211 increases the transfer rate and informs the rate controller 1111 of the file-source node 900a of the calculated transfer rate through the RTT handler 1219 (step S1483). Steps S1281 and S1283 may be implemented in pseudo code as follows:

if current_loss_rate<0.000001 or current_loss_rate in loss_rate_mean+−0.05% or current_loss_rate in previous_loss_rate+−0.05% then {
if previous_set_speed×0.8>current_rate then !stable;
else if linear_speed_up_credit>0 then linear_speed_up_credit--and !stable;
else stable and new_rate=1.1×(previous_set_rate+current_rate)/2}
   where current_loss_rate represents the current loss rate, loss_rate_mean represents the mean of historical loss rates, previous_loss_rate represents the previous loss rate, linear_speed_up_credit represents a credit for speed up, stable is a Boolean value indicating whether the real-time network situation is stable, and previous_set_rate represents the last transfer rate that was instructed to the rate controller 1111. The current and previous loss rates are calculated in step S1411 in the last two iterations. The mean of historical loss rates is calculated in step S1413. The credit for speed up may be modified in steps S1433 and S1483.

In alternative embodiments, the rate controller 1211 may apply only two determinations S1431 and S1481 and the corresponding operations S1433 and S1483 for adjusting the transfer rate of the file-source node 900a. In addition, relevant parameters for the determinations S1431 and S1481 are obtained in steps S1411, S1413 and S1417.

In alternative embodiments, the rate controller 1211 may apply only one determination S1451 and the corresponding operation S1453 for adjusting the transfer rate of the file-source node 900a. In addition, relevant parameters for the determination S1451 are obtained in steps S1413, S1415 and S1417.

In alternative embodiments, the rate controller 1211 may apply only one determination S1471 and the corresponding operation S1473 for adjusting the transfer rate of the file-source node 900a. In addition, relevant parameters for the determination S1471 are obtained in step S1419.

A user may pause a file transceiving through an MMI resident in the client 110. When a file download task (from the storage server 120 to the client 110) is paused, the client 110 may send a pause command with the file token carried in an UDP packet to request the storage server 120 for stopping the transmission of data fragments of the file associated with the file token. After detecting a signal indicating that the file download task is resumed from the MMI, the client 110 sends another pull file header with the same file token to request the storage server 120 for resuming the transmission of data fragments of the file associated with the file token. When a file upload task (from the client 110 to the storage server 120) is paused, the client 110 sends a pause command with the file token carried in an UDP packet to request the storage server 120 for stopping the aforementioned reporting mechanism for the file associated with the file token. After detecting a signal indicating that the file upload task is resumed from the MMI, the client 110 sends another push file header with the same file token to request the storage server 120 for resuming the aforementioned reporting mechanism for the file associated with the file token. The control channel handler 530 may instruct the data channel handler 550 to send the pause command, the push file header and the pull file header to the storage server 120.

A user may abort a file transceiving through an MMI resident in the client 110. When a file download task (from the storage server 120 to the client 110) is aborted, the client 110 may send an abort command with the file token carried in an UDP packet to request the storage server 120 for terminating the corresponding task of the file associated with the file token. After detecting a signal indicating that the file download task is started again from the MMI, the client 110 sends a new pull file header with a new file token to the storage server 120. When a file upload task (from the client 110 to the storage server 120) is aborted, the client 110 sends an abort command with the file token carried in an UDP packet to request the storage server 120 for terminating the corresponding task for the file associated with the file token. After detecting a signal indicating that the file upload task is started again from the MMI, the client 110 sends a new push file header with a new file token to the storage server 120. The control channel handler 530 may instruct the data channel handler 550 to send the abort command, the push file header and the pull file header to the storage server 120.

Some or all of the aforementioned embodiments of the method of the invention may be implemented in a computer program such as an operating system for a computer, a driver for a dedicated hardware of a computer, or a software application program. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier such as a DVD, CD-ROM, USB stick, a hard disk, which may be located in a network server accessible via a network such as the Internet, or any other suitable carrier.

The computer program may be advantageously be stored on computation equipment, such as a computer, a notebook computer, a tablet PC, a mobile phone, a digital camera, a consumer electronic equipment, or others, such that the user of the computation equipment benefits from the aforementioned embodiments of methods implemented by the computer program when running on the computation equipment. Such the computation equipment may be connected to peripheral devices for registering user actions such as a computer mouse, a keyboard, a touch-sensitive screen or pad and so on.

Although the embodiment has been described as having specific elements in FIGS. 2 and 3, it should be noted that additional elements may be included to achieve better performance without departing from the spirit of the invention. While the process flows described in FIGS. 8, 11, 12 and 14 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for transmitting files through networks, comprising:
a communications interface; and
a processing unit, coupled to the communications interface, determining whether a real-time network situation is favorable; determining a first protocol over Transmission Control Protocol (TCP) to carry out a file upload or download task if the real-time network situation is favorable; determining a second protocol over User Datagram Protocol (UDP) to carry out the file upload or download task if the real-time network situation is not favorable; and sending or receiving a plurality of data fragments to or from a storage server by the determined protocol via the communications interface.

2. The apparatus of claim 1, wherein the processing unit sends an Round-Trip Time (RTT) request to the storage server at a first moment; receives an RTT response from the storage server at a second moment; calculates an RTT between the first and second moments; determines that the real-time network situation is favorable when the RTT is shorter than a threshold; and determines that the real-time network situation is not favorable when the RTT is longer than the threshold.

3. The apparatus of claim 1, wherein the processing unit generates a file token by using a pseudorandom number generator after determining the second protocol over UDP to carry out the file upload or download task, wherein the pseudorandom number generator is an algorithm for generating a sequence of numbers whose properties approximate the properties of sequences of random numbers, and the file token is used in the file upload or download task.

4. The apparatus of claim 3, wherein the processing unit establishes a TCP connection with the storage server after determining the first protocol over TCP to carry out the file upload or download task; and sends or receives the data fragments to or from a storage server through the TCP connection.

5. The apparatus of claim 1, wherein the TCP acknowledges each data fragment it receives from the storage server and the UDP does not implement a retransmission mechanism.

6. The apparatus of claim 1, wherein the processing unit continuously receives UDP packets from a file-source node via the communications interface, where each UDP packet comprises a data fragment of a file, when the real-time network situation is not favorable; detects a missing data fragment according to information of the received data fragments; calculates a timeout moment for the missing data fragment; and requests the file-source node to resend the missing data fragment via the communications interface after the timeout moment has expired.

7. The apparatus of claim 6, wherein the timeout moment is calculated using the following Equation:
TO=T_now+Len_missing/RTT_current,
wherein TO represents the timeout moment, T_now represents the current time, Len_missing indicates length of a missing data fragment, and RTT_current represents the latest Round-Trip Time (RTT).

8. The apparatus of claim 6, wherein the UDP packet stores position information and the position information defines a location for the file in which the data fragment resides.

9. The apparatus of claim 8, wherein the processing unit generates and stores a pending-bytes record in a memory or a storage device of the file-destination node after detecting the missing data fragment, wherein the pending-bytes record comprises the position information and the timeout moment.

10. The apparatus of claim 9, wherein the processing unit, at a reporting moment, inserts the pending-bytes record into a report when the timeout moment of the pending-bytes record has expired, and sends the report to the file-source node via the communications interface to request that the file-source node resend the missing data fragment.

11. The apparatus of claim 10, wherein the processing unit deletes the pending-bytes record after receiving the missing data fragment from the file-source node via the communications interface.

12. The apparatus of claim 6, wherein the UDP packet stores a file token and the file token identifies which file contains the data fragment.

13. The apparatus of claim 1, wherein the processing unit, when the real-time network situation is not favorable, collects a plurality of parameters and determines whether the collected parameters show that a condition has been met every predefined time period; calculates a new transfer rate when the collected parameters show that the condition has been met; and informs a file-source node of the new transfer rate via the communications interface, thereby enabling the file-source node to send the rest of the data fragments of a file associated with a file token by UDP packets at the new transfer rate to the apparatus.

14. The apparatus of claim 13, wherein the processing unit determines that a speed-down condition has been met when a current loss rate is significantly worse than the average of historical loss rates, calculates the new transfer rate when the speed-down condition has been met, and the historical loss rates are associated with the file token.

15. The apparatus of claim 13, wherein the processing unit determines whether a speed-up condition has been met when the speed-down condition is not met; and determines that the speed-up condition has been met and calculates the new transfer rate when the current loss rate is stable.

16. The apparatus of claim 13, wherein the processing unit determines whether a real-time network situation meets a speed-down condition for p times in a row, and calculates the new transfer rate when the real-time situation meets the speed-down condition for p times in a row.

17. The apparatus of claim 13, wherein the processing unit determines that a speed-down condition has been met when an IO state of a storage device of the apparatus is busy, and calculates the new transfer rate when the speed-down condition has been met.

18. A non-transitory computer program product for transmitting files through networks when executed by a processing unit of a client, the computer program product comprising program code to:
determine whether a real-time network situation is favorable;
determine a first protocol over Transmission Control Protocol (TCP) to carry out a file upload or download task if the real-time network situation is favorable;
determine a second protocol over User Datagram Protocol (UDP) to carry out the file upload or download task if the real-time network situation is not favorable; and
send or receive a plurality of data fragments to or from a storage server by the determined protocol via the communications interface.

19. The non-transitory computer program product of claim 18, wherein the program code is further to:
send an Round-Trip Time (RTT) request to the storage server at a first moment;
receive an RTT response from the storage server at a second moment;
calculate an RTT between the first and second moments;
determine that the real-time network situation is favorable when the RTT is shorter than a threshold; and
determine that the real-time network situation is not favorable when the RTT is longer than the threshold.

20. The non-transitory computer program product of claim 18, wherein the program code is further to:
generate a file token by using a pseudorandom number generator after determining the second protocol over UDP to carry out the file upload or download task, wherein the pseudorandom number generator is an algorithm for generating a sequence of numbers whose properties approximate the properties of sequences of random numbers, and the file token is used in the file upload or download task

21. The non-transitory computer program product of claim 18, wherein the program code is further to:
continuously receive UDP packets from a file-source node, wherein each UDP packet comprises a data fragment of a file, when the real-time network situation is not favorable;
detect a missing data fragment according to information of the received data fragments;
calculate a timeout moment for the missing data fragment; and
request the file-source node to resend the missing data fragment after the timeout moment has expired,
wherein the UDP packet stores position information and the position information defines a location for the file in which the data fragment resides.

22. The non-transitory computer program product of claim 21, wherein the UDP packet stores a file token and the file token identifies which file contains the data fragment.

23. The non-transitory computer program product of claim 18, wherein the program code is further to:
collect a plurality of parameters and determining whether the collected parameters show that a condition has been met every predefined time period when the real-time network situation is not favorable;
calculate a new transfer rate when the collected parameters show that the condition has been met; and
inform a file-source node of the new transfer rate and a file token, thereby enabling the file-source node to send the rest of the data fragments of a file associated with the file token by UDP packets at the new transfer rate to the client.
